(19) United States
(12) Patent Application Publication
(10) Pub. No.: US 2003/0010232 A1
(43) Pub. Date: Jan. 16, 2003

(54) Hydrophobic adhesive masking tape with selective transparency

(76) Inventor: Ruben Castellanos, Los Angeles, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/903,086

(22) Filed: Jul. 10, 2001

(51) Int. Cl. B41L 23/00; B41L 23/12

(52) U.S. Cl. 101/147

(57) ABSTRACT

A combination used in an offset printer comprises a water pickup roller having an outside surface and mounted so that the roller is able to rotate within an offset printer frame adjacent to a water pan for pickup of water. A tape strip has plural holes spaced along the length of the strip. The strip may be coiled to form a roll of material that can be dispensed as needed. A portion of the roll is removed and adhesively attached to the roller's outer surface at positions on the roller where it is desired to limit the amount of water picked-up by the roller.

### BACKGROUND OF THE INVENTION

1. FIELD OF THE INVENTION

This invention relates generally to printer rollers and more particularly to a tape useful for reducing the amount of water that may be picked up by the printer roller during use.

2. DESCRIPTION OF RELATED ART

The following art defines the present state of this field:

Jensen, U.S. Pat. No. 3,292,525 describes a system for removing air-borne contaminants including the products of combustion and volatilization incident to cooking from a cooking area located in an air conditioned room with a minimum of disturbance or displacement of the conditioned air by such removal comprising air supply means including a first blower means having an intake externally of said room for directing a confined air stream to the cooking area, an air discharge connected to the supply means at the cooking area for discharging the air stream into the room adjacent to the cooking area in a curtain projecting over the cooking area to pick up said contaminants and to shield the conditioned air of the room therefrom, and air exhaust means, separate from said supply means and including a second blower means having an air receiving inlet disposed adjacent to the cooking area in alignment with the discharge to receive the curtain of air and contaminants picked up thereby and an exhaust outlet externally of the room and separate form said intake for release of the air stream and said contaminants, the air supply means and the air exhaust means being substantially volumetrically balanced so that the volume of air supplied in said air stream to the room substantially equals the volume of air and contaminants removed in said air stream from the room.

Lake, U.S. Pat. No. 3,902,416 describes a moisture dispensing assembly for a lithographic printing press including a fountain roller having a sufficiently hydrophilic surface to pick up and retain water or the like liquid thereon and a wiper member having a flat surface of elastomeric material engaging the roller to meter a film of liquid onto the roller surface, from which proper quantities of liquid are transferred to the printing system. In addition to having the prior art capability of setting the angular position and pressure of the wiper with respect to the fountain roller surface, the wiper is mounted for movement along an arcuate path about the roller surface between the liquid pickup point and crown of the roller, thereby to change the position of the wiper with respect to the crown and compensate for splitting of the liquid thereat due to gravity. This insures better control of the quantity of liquid supplied to the printing system. In a preferred embodiment of the dispensing assembly, a liquid pump and filter arrangement is employed to maintain a proper level of liquid in a liquid supply trough in which the fountain roller is mounted for rotation. In another embodiment, dams or caps taking the form of plates are mounted on the ends of the fountain roller for engagement along an edge thereof with the elastomeric wiper. The end dams minimize the accumulation of liquid at the roller ends.

Smith et al., U.S. Pat. No. 5,222,434 describes a roller for moving one of ink and water through a printing press is disclosed as an elastomeric covering on a solid journal. The elastomeric covering includes spiral lands and valleys adjacent the lands having depths ranging from 0.002 to 0.004 inch for ducting water, and ranging from 0.002 to 0.015 inch for ducting ink. At valley depths of greater than 0.015, ink is carried solely on the lands for the purpose of lubricating the ductor system. One embodiment includes reversed spiral land and valley end segments that direct ink inwardly from the ends of the rollers to prevent ink buildup at those positions on a ductor roller.

Laumann et al., U.S. Pat. No. 5,680,815 describes a dampening unit for an offset printing machine having an applicator roller including a central section and two oppositely disposed tapered end sections to prevent the transference of excessive amounts of dampening medium to the printing plate is disclosed. The boundaries between each of the end sections and the central section of the applicator roller are located adjacent predetermined regions defined on the plate cylinder to ensure a uniform dampening medium film is produced across the entire format width of the material to be printed.

Huang, U.S. Pat. No. 5,772,524 describes a water retarding golf club grip having an outer shock absorbing polyurethane layer, an intermediate water resistant layer, and an inner felt layer, such layers being bonded together to define an elongated resilient strip which is spirally wrapped about the grip-receiving portion of a golf club shaft by a double-sided adhesive watertight tape adhered to the underside of the felt layer with the side edges of the tape being bent upwardly over the sides of the strip to restrain entry of water into the felt layer.

The prior art teaches the use of making tapes but does not teach a tape having holes arranged for effectively controlling the amount of water picked up by a roller in an offset printing process. The present invention fulfills these needs and provides further related advantages as described in the following summary.

### SUMMARY OF THE INVENTION

The present invention teaches certain benefits in construction and use which give rise to the objectives described below.

In the offset printing process, a water pickup roller is used to provide water masking of ink in the process. When a work piece is narrower than the length of the water pickup roller, excess water tends to accumulate on the roller and cause quality problems with the printing process. This invention solves this problem by using an adhesive tape strip to coat the roller where it is desired to cut-down on the amount of water picked up. However, it has been found that the full masking of portions of the roller does not work well. The water pickup roller has an outside surface and is mounted so that the roller is able to rotate within an offset printer frame adjacent to a water pan for pickup of water. The tape strip of the present invention solves the water pickup problem by providing plural holes spaced along the length of the strip. The size of the holes determines how much water is picked up in the areas covered by the tape strip. The strip may be coiled to form a roll for dispensing segment by segment. A segment of the roll is removed and adhesively attached to the roller's outer surface at positions on the roller where it is desired to limit the amount of water picked up by the roller.

A primary objective of the present invention is to provide an apparatus and method of use of such apparatus that provides advantages not taught by the prior art.

Another objective is to provide such an invention capable of changing the amount of water pickup in an offset printing process.

A still further objective is to provide such an invention capable of being produced at low cost while reserving ease of use.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a portion of an offset printer roll set of the preferred embodiment of the invention showing a water masking tape adhered thereto; and

FIG. 2 is a perspective view of plural rolls of a water masking tape for use thereon.

### DETAILED DESCRIPTION OF THE INVENTION

The above described drawing figures illustrate the invention in at least one of its preferred embodiments, which is further defined in detail in the following description.

The present invention is an adhesive masking tape comprising an elongated strip, generally referred to herein by the numeral 10, of a hydrophobic flexible plastic sheet goods such as polypropylene or polyester at, preferably, from 0.001 to 0.003 inches in thickness, but which may be made in a different thickness as may best suit a given application. The strip 10 is adhesively coated on one side with a water resistance adhesive 12 as is well known in the art, so that it may be easily adhered to a surface where it is used. Plural holes 20 are placed in the strip 10 as shown in FIG. 2, and these holes are arranged in spaced relationship longitudinally on the strip 10. The strip is preferably coiled into a roll so that small segments 30 of the strip 10 may be removed for use as needed.

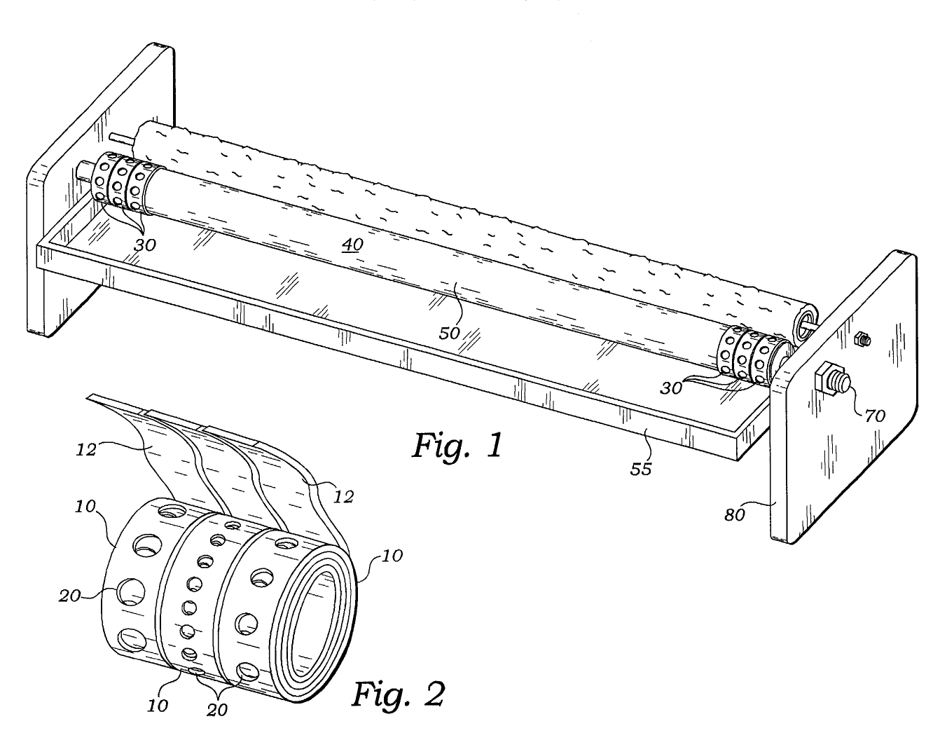

When adhesively attached, as shown in FIG. 1, on the outer surface 40 of a water pickup roller 50, in an offset printer, the locations on the roller 50 where the tape has been placed will only pick up water from a water pan 55 where the holes 20 are located on the strip 10. Therefore, the tape provides the ability to mask a selected percent of the surface of the water pickup roller 50. This is of most benefit usually at the extreme ends of the roller 50, as shown in FIG. 1, when the workpiece (the piece that is printed on) is narrower than the roller 50. This is because the workpiece does not pick up water from these ends of the roller and this excess water tends to drip and spread to surface portions of the printing process where it is not desired and can cause print quality problems.

In an alternate embodiment of the present invention, plural tape strips 10 of the type defined above are provided as a set, where each is coiled into a roll, as shown in FIG. 2. In this embodiment, each of the strips 10 has holes of a different size. This provides the advantage of being able to select a tape strip 10 that can mask the water pickup roller 50 at a selected percent to fit the need in each case. Which tape strip 10 to use in any given situation is discovered by trial and error, but skill in this particular type of application is acquired rapidly.

In a still further alternate embodiment, a combination comprises the water pickup roller 50 having an outside surface 40 and a means for mounting, such as the axle 70, of the pickup roller 50 to a printer frame 80 adjacent to the water pan 55. At least one segment 30 of tape strip 10 having plural holes 20 therethrough, is adhered to the outside surface of the water pickup roller 50 in circumferential abutment at a selected position for masking water pickup by the water pickup roller 50. This is clearly shown in FIG. 1 where three separate tape strip segments 30 are placed, side-by-side, on each end of the roller 50.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A tape apparatus comprising an elongate strip of a flexible sheet goods, the strip having an adhesive coating on one side thereof and plural holes therethrough arranged in spaced relationship longitudinally on the strip, the strip coiled into a roll for segment removal and use.

2. A tape apparatus comprising plural elongate strips, each of a flexible sheet goods having an adhesive coating on one side thereof and plural holes therethrough arranged in spaced relationship longitudinally on the strip, the strip coiled into a roll for segment removal and use, each of the strips providing holes of a size distinguished from the other of the strips.

3. A combination used in an offset printer comprising a water pickup roller having an outside surface and means for mounting the pickup roller to a printer frame adjacent to a water pan, and at least one tape strip having plural holes therethrough, wherein the at least one tape strip is adhered to the outside surface of the water pickup roller in circumferential abutment at a position for masking water pickup by the water pickup roller.
